(19) United States
(12) Patent Application Publication
(10) Pub. No.: US 2019/0199859 A1
(43) Pub. Date: Jun. 27, 2019

(54) SYSTEM AND METHOD FOR PROVIDING PERSONALIZATION BADGES FOR ENHANCED CUSTOMER SERVICE EXPERIENCE

(71) Applicant: ServiceNow, Inc., Santa Clara, CA (US)

(72) Inventors: Reinhard P. Klemm, Basking Ridge, NJ (US); Shmuel Shaffer, Palo Alto, CA (US)

(21) Appl. No.: 16/224,220

(22) Filed: Dec. 18, 2018

Related U.S. Application Data
(63) Continuation of application No. 13/789,160, filed on Mar. 7, 2013, now abandoned.
Application No. 13/789,160 is a continuation-in-part of application No. 12/978,904, filed on Dec. 27, 2010, now abandoned.

(51) Int. Cl. H04M 3/51; G06Q 10/00; G06Q 30/00

(52) U.S. Cl. CPC H04M 3/5191; G06Q 30/016; G06Q 10/00

(57) ABSTRACT

A system for providing customized customer service interaction between a user and an enterprise is disclosed. The system includes a badge and a badge reader. The badge is installed at a user device, and the badge reader is installed at the enterprise. The badge is configured to generate an access key for a customer's social network account based on a customer's work request to the enterprise. The badge reader is configured to retrieve user data as permitted by the associated access key from the badge, and route a work request of the user to a suitable agent of the enterprise based on the user data.

### CROSS-REFERENCE TO RELATED APPLICATIONS

This application is continuation-in-part of U.S. application Ser. No. 12/978,904 filed Dec. 27, 2010, entitled “SYSTEM AND METHOD FOR PERSONALIZED CUSTOMER SERVICE OBJECTS IN CONTACT CENTERS,” which is incorporated herein by reference in its entirety.

### BACKGROUND

### Field of the Invention

Embodiments of the present invention generally relate to a system and method for providing customer service and particularly to a system and method for providing personalized customer service utilizing contact center technology.

### Description of Related Art

Remote customer service rendered by a contact center through telephony, email, chat, or Internet interfaces tends to disregard the personas, preferences, characteristics, opinions, inclinations, idiosyncrasies, circumstances, situations, and tastes of customers. That is, the “personal touch” that a customer typically experiences when visiting a store where he or she is familiar to store representatives is lost because remote contact centers generally have very limited, if any, knowledge of the personal details of customers. Further, relationships can be difficult to establish in remote contact centers because there is often little or no personal continuity across multiple interactions. In other words, each time a customer calls, they are typically connected to a different agent in the contact center. This total lack of knowledge can result in customer disloyalty and dissatisfaction, leading to ineffectiveness and higher operating costs for the contact center and loss of revenue generating or cost reduction opportunities for an enterprise

A conventional customer contact center typically utilizes caller identification and self-disclosure methods to establish some knowledge about the callers. Caller identification is usually attained through a variety of methods, for example, by requiring the caller to provide a phone, credit card, or account number. Additional self-disclosure can be accomplished by asking the customer for her name or preferred language of interaction, etc. The conventional contact center system can also automatically determine the caller's identity through the caller's phone number, email, address, or similar. Moreover, the conventional contact center system can try to establish the caller's geographic area through the phone number or IP address of the caller or through the called phone number or email address or Web form URL or similar. To support the latter, some businesses usually advertise a different phone number, email address, Web form URL in different geographic areas. The conventional contact center utilizes the caller's geographic area for a whole range of personalization choices, from selection of an agent for a customer to offering only services, which are legal in the caller's geographic area.

However, these conventional methods of caller identification and self-disclosure, used in the conventional contact center system, provide very limited amounts of data for offering personalized services to the customers. For example, caller identification enables retrieving data that the business has already collected about the customer but misses all rich customer contexts that an employee of the above-mentioned small neighborhood store would know about. This is particularly constraining if the customer is new. Further, self-disclosure does not produce substantially more data on whose basis to personalize services to the customers because prompting the customer for rich customer context would be a long, tedious and unacceptable process.

There is thus a need for an improved customer support service system and method to provide personalized customer support services to the customers.

### SUMMARY

Embodiments in accordance with the present invention provide a system for providing customized customer service interaction between users and an enterprise. The system includes a badge module and a badge reader module. The badge module and the badge reader module may be referred to herein as a “badge” and a “badge reader,” respectively. For example, the badge may include a software module installed within a customer device, and the badge reader may include a software module installed within the enterprise. The badge is configured to generate an access key for one or more of a customer's social network accounts during the badge setup or a badge reconfiguration. The badge is configured to retrieve customer data from the badge that, in turn, requests customer data from the social network account based on the access key. Depending upon data access restrictions set by the customer, at least a portion of the customer data may be transmitted to the badge reader module. The data access restrictions may be customized for individual enterprises based upon factors such as the permitted usage by that enterprise, e.g., one-time usage, valid only for a limited time, valid for an unlimited time and unlimited number of uses, etc. The customer data that the badge reader receives from the badge therefore includes specifications of usage restrictions that the customer configured. The badge reader is further configured to interface to (or be integrated with) a contact (or call) routing system that routes a work request of the customer to a suitable agent based on the customer data.

Embodiments in accordance with the present invention further provide a computer-implemented method for providing a customized customer service interaction between users and an enterprise. The method includes receiving a work request from a customer or prospective customer (generically, “customer”), and retrieving an access key for a social network account of the customer, retrieving and storing by the badge customer data, and selectively transmitting the customer data to a badge reader associated with an enterprise. Further, the method includes retrieving a customer data available from a social network based on the access key, and selecting an agent of the enterprise for providing personalized service to the customer based on the retrieved customer data.

Embodiments in accordance with the present invention further provide a computer readable medium storing computer readable instructions that, when executed by a processor coupled to a memory, perform methods in accordance with one or more embodiments of the present invention.

Embodiments of the present invention can provide a number of advantages depending on the particular configuration. First, embodiments provide a large amount of data for the purpose of fine-grained personalization of customer service that is beneficial to both businesses and customers. The embodiments allow a business to tap into a rich set of customer context and data beyond what it may have stored about the customer. The embodiments utilize this rich customer context in an automatic or manual fashion in the contact center to personalize a wide range of parameters of the ensuing customer service interaction. The customer context contains static data about the customer (name, gender, education, etc.) as well as dynamic data (e.g., hobbies, TV interests, friends, and customer posts on his/her Facebook Wall and to the business Twitter account). The customer can also add more contact center-relevant preferences and details about them, for example, their likes and dislikes, so that the interaction with the contact center may be more personalized and enjoyable. This additional data may be immediately helpful to the delivery of personalized customer service (e.g., “I prefer voice interactions, with female customer service representatives”).

Next, embodiments of the present invention support personalized, useful, and efficient marketing campaigns for the customers of a contact center. For example, embodiments may find that a particular customer prefers red wine or blue dresses (from social network account of the customer), then it may inform the customer that there is an ongoing sale on such items. Hence, embodiments provide a better mode of operation as compared to the norm today in the self service field where a company renders the same marketing message—referring to an ongoing marketing campaign—to all customers regardless of their interest.

Further, embodiments of the present invention address security aspect of the customers. Some users may be reluctant to disclose to others information gathered by use of their social network access keys (including to automated customer service systems) fearing that the information may be sold or given to others, thus facilitating unwanted disclosure to undesired entities. Hence, embodiments of the present invention may utilize an access key such that data gathered using the access key is supplied to another entity no more than once.

For security reasons, embodiments in accordance with the present invention do not allow transfer of data from one badge reader to another badge reader.

Furthermore, the badge provided by embodiments of the present invention may be applicable at any business and communication modality. The customer can use the badge when interacting with any business that is equipped with a badge reader, and over any of the common customer service communication modalities. The setup and configuration is therefore required only once (with occasional updates) and not before every customer service interaction. During setup and configuration, the badge may retrieve public customer data from a social network.

During a customer service interaction, the badge transmits some part of data gathered during setup and configuration to a badge reader, according to what data the customer allows the badge reader to see. The badge reader never accesses the social network directly and does not get to use the access key.

A customer service interaction may proceed as follows. Suppose a user walks into a ‘BestBuy’ store with a smart phone in which the badge is installed. As the customer walks in, the badge reader at the ‘BestBuy’ store interacts with the badge installed at the smart phone of the customer to retrieve from the badge module the user data from social network accounts of the user, which had been previously retrieved by use of an access key. The badge transmits to the badge reader only the social network customer data that the customer authorized for use by BestBuy's badge reader, as well as the additional preferences and details that may be stored in the badge.

These and other advantages will be apparent from the disclosure of the embodiments of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed.

However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments of the present invention include a tangible storage medium or distribution medium and prior art-recognized equivalents and successor media, in which the software implementations of embodiments of the present invention are stored.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments of the present invention include a tangible storage medium or distribution medium and prior art-recognized equivalents and successor media, in which the software implementations of embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The term “switch” or “server” as used herein should be understood to include a PBX, an ACD, an enterprise switch, or other type of communications system switch or server, as well as other types of processor-based communication control devices such as media servers, computers, adjuncts, etc.

As used herein in connection with embodiments of the present invention, the term “customer” denotes a party external to the entity that desires to use the personalized information, regardless of whether or not that party is a “customer” in the sense of having a commercial relationship with the contact center or with a business represented by the contact center. “Customer” is thus shorthand, as used in the description of embodiments herein, for the other party to an entity that desires to use the personalized information.

The preceding is a simplified summary of embodiments of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings, and wherein:

FIG. 1 illustrates an example system embodiment of the present invention;

FIG. 2 illustrates an exemplary architecture in which the various embodiments may be implemented;

FIG. 3 illustrates a flowchart depicting an embodiment of the present invention;

FIG. 4 illustrates an exemplary user's profile page on a social network website; and

FIG. 5 illustrates an exemplary user's comments on a friend's post on a social network site.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited for use with, e.g., a system having an ACD or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

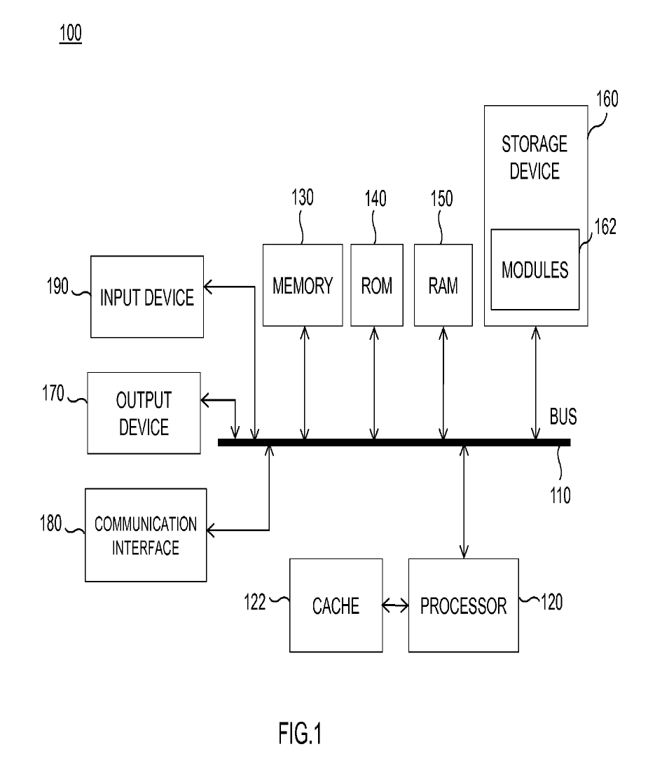

With reference to FIG. 1, an exemplary system 100 includes a general-purpose computing device 100, including a system bus 110 and a processing unit (CPU or processor) 120 that couples various system components including the system memory 130 such as read only memory (ROM) 140 and random access memory (RAM) 150 to the processor 120. The system 100 may include a cache 122 of high speed memory connected directly with, in close proximity to, or integrated as part of the processor 120. The system 100 copies data from the memory 130 and/or the storage device 160 to the cache 122 for quick access by the processor 120. In this way, the cache 122 provides a performance boost that avoids processor 120 delays while waiting for data. These and other modules may control or be configured to control the processor 120 to perform various actions. Other system memory 130 may be available for use as well. The memory 130 may include multiple different types of memory with different performance characteristics. It may be appreciated that the disclosure may operate on a computing device 100 with more than one processor 120 or on a group or cluster of computing devices networked together to provide greater processing capability. The processor 120 may include any general purpose processor and a hardware module or software module 162 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 may include software modules 162 for controlling the processor 120. Other hardware or software modules are contemplated. The storage device 160 may be connected to the system bus 110 by a drive interface. The drives and the associated computer readable storage media provide non-volatile storage of computer readable instructions, data structures, program modules and other data for the computing device 100. In one embodiment of the present invention, a hardware module that performs a particular function includes the software component stored in a computer-readable medium in connection with the necessary hardware components, such as the processor 120, bus 110, output device 170, and so forth, to carry out the function. The basic components are known to those of skill in the art and appropriate variations are contemplated depending on the type of device, such as whether the device 100 is a small, handheld computing device, i.e., a smartphone, a desktop computer, or a computer server.

Although the exemplary embodiment described herein employs the hard disk 160, it should be appreciated by those skilled in the art that other types of computer readable media which may store data that are accessible by a computer, such as magnetic cassettes, flash memory cards, digital versatile disks, cartridges, read only memory (ROM) 140, random access memories (RAMs) 150, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 180 represents any number of input mechanisms, such as a microphone for speech, a touch-sensitive screen for gesture or graphical input, keyboard, mouse, motion input, speech and so forth. An output device 170 may also be one or more of a number of output mechanisms known to those of skill in the art. In some instances, multimodal systems enable a user to provide multiple types of input to communicate with the computing device 100. Communication interface 190 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labelled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. Further, use of the term “processor” should not be construed to refer exclusively to hardware capable of executing software. Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 may practice all or part of the recited methods, may be a part of the recited systems, and/or may operate according to instructions in the recited non-transitory computer-readable storage media. Such logical operations may be implemented as modules configured to control the processor 120 to perform particular functions according to the programming of the module. For example, FIG. 1 illustrates the modules 162 in the storage device 160 configured to control the processor 120. These modules may be stored on the storage device 160 and loaded into RAM 150 or memory 130 at runtime or may be stored as would be known in the art in other computer-readable memory locations.

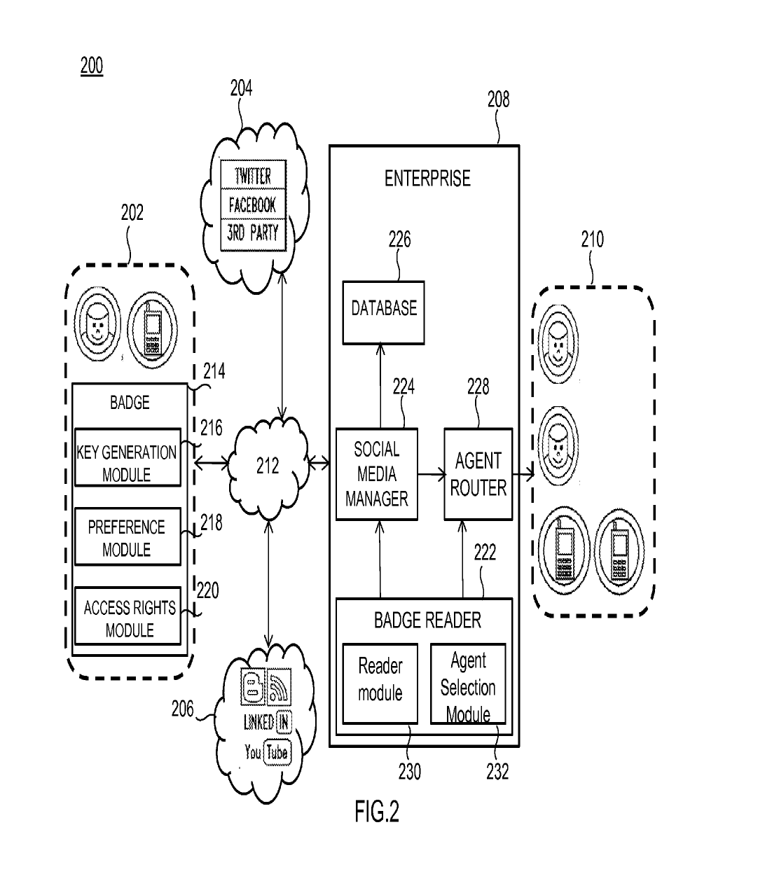

Having disclosed some components of a computing system, the disclosure now turns to FIG. 2, which illustrates an exemplary architecture 200 in which the various embodiments of the present invention may be implemented. As shown in FIG. 2, the exemplary architecture 200 includes user terminals 202 associated with customers, direct social media channels 204 (with respect to the enterprise), indirect social media channels 206 (with respect to the enterprise), an enterprise 208, and an agent terminal 210. The elements 202-208 may be connected via at least one network 212.

The network environment 200 includes a user terminal 202 connected to an enterprise 208 via network 212. The network 212 may include, but is not restricted to, a communication network such as the Internet, PSTN, Local Area Network (LAN), Wide Area Network (WAN), Metropolitan Area Network (MAN), and so forth. In an embodiment of the present invention, the network 212 may be a data network such as the Internet.

In the various embodiments of the present invention, the enterprise 208 may be configured to support a variety of communication modes. For example, the enterprise 208 may be configured to support real-time communication modes. That is, communication modes which are “live” or in which there is no appreciable latency between the user and the agent communication. Such communication modes may include telephony communications (land-line and mobile), instant messaging, Internet relay chat (IRC) or other chatting modes, video-conference, teleconference, or telepresence, to name a few. However, the various embodiments are not limited in this regard and any other type of real-time communication mode may also be used.

Alternatively, or in combination with real-time communication modes, the enterprise 208 may also be configured to support time-shifted communication modes. That is, communication modes in which messages between the users and the agents are stored at some intermediate point. For example, such communication modes may include email, electronic message boards, social networks, or any other communication mode in which messages from the agent to the user or the user to the agent are stored at some intermediate point, allowing the recipient to access the messages without the need to maintain an active communication link with the sender.

The enterprise 208 may be configured to support the communication modes described above using a wide variety of devices for the user terminals 202, including devices operating over analog or digital communication channels designed for the delivery of information to users in an audio form, a visual form (including static and dynamic visual elements), or any combination thereof. For example, in some embodiments of the present invention, the enterprise 208 may be configured to support the user terminals 202 consisting of a general purpose computer device connected to the data network 212, as described above with respect to FIG. 1. Such devices may include a desktop computer, portable computer, personal digital assistant, smartphone, or any other type of appliance or device having access to one or more data networks supporting real-time and/or time-shifted communication modes over such networks. However, the various embodiments are not limited in this regard. For example the user terminals 202 may be devices supporting real-time and/or time-shifted communications over telephony networks or any other type of communication networks. Such devices may include land-line telephone devices, mobile or cellular telephone devices, videophone devices, and the like. However, the various embodiments are not limited in this regard and any other types of devices may be used for user terminals 202.

Additionally, the architecture 200 may include agent terminals 210 associated with agents of the enterprise and configured for providing services to the customers located at the user terminals 202. In particular, the enterprise 208 connects and manages the communication link or session between the user terminals 202 and the agent terminals 210. Although the agent terminals 210 are shown in FIG. 2 as being connected to the network 212 via the enterprise 208, the various embodiments are not limited in this regard. Rather, in some embodiments of the present invention, one or more of the agent terminals 210 may be directly connected to the network 212 and may communicate with the enterprise 208 via network 212. The agent terminals 210, like the user terminals 202 may be configured to support real-time and/or time-shifted communication modes. Accordingly, the description above regarding the communication modes and devices for the user terminals 202 is equally applicable to the agent terminals 210.

As shown in FIG. 2, social media channels 204 and 206 are accessible through the network 212 and consist of direct and indirect social media channels, respectively, with respect to the enterprise 208. As used herein, a “direct” social media channel refers to a social media channel that is directly related or associated with the enterprise 208. For example, the social media channel may be a publically accessible communications channel that is managed and controlled by the customer care center of the enterprise 208, such as a customer support user forum established and managed by the enterprise 208. However, in the various embodiments, such direct social media channels 204 may also include online communications channels which are partially managed or controlled by the enterprise. For example, a Facebook® or Twitter® site or page established by the enterprise. However, the various embodiments are not limited to the examples above and a direct social media channel 204 may include any other type of communication channel in which the content is at least partially managed or controlled by the enterprise.

In contrast, an “indirect” social media channel refers to a social media channel in which the enterprise 208 is a participant and is not involved in the management, establishment, or control thereof. Such indirect social media channels 206 may include channels that are viewable by the general public, including channels requiring registration or having some type of authentication procedures for accessing the channel. For example, a blog or other online communications channel established by one or more customers of the enterprise. In such a communication channel, the enterprise 208 may monitor and interact with customers, but others may control the content in the communication channel. However, the various embodiments are not limited to the examples above and an indirect social media channel may include any other type of communication channel in which the enterprise does not have control of the content posted thereon.

According to an embodiment of the present invention, the user terminal 202 includes a badge 214. The badge 214 may be a software application running on the user terminal 202. A user may download and install the badge 214 at the user terminal 202. The user terminal 202 may include a computing device of the user, for example, a smart phone, a laptop, a desktop, a tablet etc. According to an embodiment of the present invention, the badge 214 includes a key generation module 216, a preference module 218, and an access rights module 220.

The key generation module 216 may be configured to generate an access key for a user's social network account.

The access key may be used by the badge module to retrieve and store the user's data from the social network account. The social networks include, but are not limited to, Facebook™, Twitter™, Linkedln™, Foursquare™ etc. The customer controls what entities may have access to the data or any subset of the stored data. Control may be implemented by setting access rights in the badge (e.g., in access rights module 220), and thereafter the badge will only supply data subject to the access rights set by the customer. For example, the customer may control which company, entity, type of entity, badge reader ID, etc. is allowed to access data and which part of the data may be accessed. Control may also include how often the data may be accessed (e.g., once only, or a limited number of times, or an unlimited number of times, etc.). Granted access also may be time-based, e.g., unlimited access until a predetermined date occurs (e.g., until tomorrow), or a predetermined amount of time elapses (e.g., for the next hour), or a predetermined event occurs (e.g., until the end of a sale), and so forth.

For example, the user's data retrieved from the social network account may include the user's name, gender, home and work locations, education level, work history, favorite TV shows, books, and music, hobbies, list of friends, spouse, posts to the business' Facebook page, comments on the business' Facebook posts, likes for other business' pages. The key generation module 216 may generate the access key when the user sets up the badge or after the user contacts the enterprise 208 for a work request.

The preference module 218 may be configured to enable a user to add user's preferences and personal details for the communication with agents of the enterprise 208. The user may add details about user's persona, preferences, characteristics, opinions, inclinations, idiosyncrasies, circumstances, situations, and tastes. In an embodiment, the user preferences and details added by the user is additional to user data found on the social network sites. The preference module 218 may be further configured to allow the customer to enter, update, or edit these pieces of data. Examples of preference data include data that may affect the rendering of customer service (hard of hearing, blind, etc.), preferred callback times (“not before 7 PM”, “not on Mondays”), and communication and customer service preferences (“I prefer voice interactions, with female customer service representatives, not younger than I am, fluent in Spanish, and with patience for tech-unsavvy customers”).

The access rights module 220 may be configured to enable the user to enter access rights for the enterprise 208 to access user data stored on the social network sites. In an embodiment, the user may want the enterprise 208 to access every data from one social network site (e.g. LinkedIn), but selected data from another social network site (e.g. Facebook). Further, the user may want the enterprise 208 to access one type of data (e.g., profession and choice related data) from his social network account, but not other type of data (e.g. personal data). The user may set these access rights using the access rights module 220. Further, the access rights module 220 may be configured to allow the user to enter access rights for use of the data by the enterprise 208. For example, the user may want storage or limited-time storage or no storage of the user data by the enterprise 208.

Further, according to an embodiment of the present invention, the enterprise 208 includes a badge reader 222, a social media manager 224, a database 226, and a contact (or call) router 228. The badge reader 222 includes a reader module 230. Badge reader 222 integrates with contact router 228 and provides contact router 228 with details that contact router 228 can use to select an appropriate agent. According to an embodiment of the present invention, the reader module 230 may be configured to retrieve the user data from badge 214 as permitted by the access rights conferred by the user, after the enterprise 208 receives the work request. The reader module 230 also may be configured to retrieve access rights from the badge 214 associated with the user. Further, the reader module 230 also may be configured to retrieve user's preference data from the badge 214 associated with the user. The agent selection module may be configured to select a suitable agent for the user based on the user data retrieved from the social network accounts of the user and the preference data retrieved from the badge associated with the user.

As user herein, the term “user data” and “preference data” refers to the set of user data that may be used by the enterprise to characterize a user. Such user data and preference data can include biographical user data, demographic user data, and external or internal behavioral user data, to name a few. The behavioral data can include the user's history with respect to the enterprise and/or any other entity or social media channel. However, the user data is not limited in this regard and can include any other type of user data used by the enterprise to characterize or classify users. Further, the user data is not limited to user data collected during an interaction between a user and the enterprise, but can include any other user data collected from one or more sources external to the enterprise. Additionally, the customer intimacy profile can be raw user data or processed user data. That is, the user data can be analyzed to characterize the user and thereafter used to provide customized or personalized services to the user/customer. For example, a customer personal profile can be a set of values associated with a user and a set of characteristics, where the values are selected based on the user data obtained. However, the disclosure is not limited in this regard and any other methods for evaluating user data to know customer preferences and to provide personalized services can be used without limitation.

In one embodiment of the present invention, the user data for providing customized customer service may be obtained by the enterprise 208 in several ways and from several sources. A primary source for collecting the user data may be the enterprise 208 itself. That is, the enterprise 208 may store information regarding the user products purchased by the user, and a history of the user's interactions with the enterprise 208. However, information included in the user data may provide a limited view of the overall characteristics of the user, specifically the characteristics of the user with respect to the enterprise 208.

Accordingly, in another embodiment of the present invention, a secondary source of user data may be utilized, i.e., social media channels. In particular, the enterprise 208 may be configured to access and monitor social media channels 204, 206 for publicly-available user data. Such social media channels may include direct social media channel 204 or indirect social media channel 206, as described above, and social media channels associated with a same or a different domain as compared to the domain of the enterprise 208. As a result, the user data collected may add additional aspects of the user's preference. Thus, the user data may more accurately reflect the overall characteristics of the user and allows the enterprise 208 to provide more customized customer services.

Further, according to an embodiment of the present invention, a tertiary source of user data may be utilized i.e. data provided by the user about him/her. This tertiary data may include data such as preference data of the user, or “contextual” data (e.g., work hours), or “limitations” data (e.g., handicaps), and so forth. The tertiary data may also affect rendering of customer services, as described above. In particular, the enterprise 208 may be configured to access the user terminal (e.g. smart phone) to access and retrieve this tertiary data. As a result, the tertiary data collected includes preference data sent by the user and may add additional aspects of the user's preference. Thus, the tertiary data may more accurately reflect the overall characteristics of the user and allows the enterprise 208 to provide more customized customer services.

Further, in another embodiment of the present invention, the user terminal 202 and the enterprise 208 may communicate in various ways. In one embodiment of the present invention, the user makes use of the user terminal 202 to establish a communication session with the enterprise 208. For example, the customer may establish a telephony communication link with the enterprise 208. In another embodiment of the present invention, the customer may establish a communication session with the enterprise over a videophone, instant messaging, or other real-time communications means.

In yet another embodiment of the present invention, one or more time-shifted communications may first occur, followed by a real-time communication session between the customer and the agent of the enterprise 208. For example, a customer may utilize user terminal 202 to indicate their desire to establish a communication session with an agent of the enterprise 208. Such an indication may be by way of providing a message or post on a social media, by sending an email to the enterprise 208, or providing the indication via any other type of time-shifted communication means.

The agent selection module 232 may be configured to select a suitable agent for the user based on the user data retrieved from the social network accounts of the user and the preference data retrieved from the badge 214 associated with the user.

The reader module 230 may be integrated with call routing, agent scripting, and screenpop software for the enterprise 208. The integration involves a software system (“social media manager”) that retrieves the rich customer context from the badge reader 222 and processes it.

The social media manager 224 may operate as a gateway to allow the enterprise 208 to communicate with the user terminal 202 in accordance with conventional gateway systems and method. However, in addition to providing gateway services, the social media manager module 224 may also provide additional functionality.

In one embodiment of the present invention, the social media manager 224 may map the user's data to actions such as IVR prompt language, music-on-hold choice, agent selection, response time, guiding the agent's interaction with the customer, post-interaction follow-up, virtual background selection for a video-agent, and much more.

Further, the social media manager 224 may operate as a data aggregator collecting information regarding the users' interactions from social media channels 204 and 206. Such aggregation may be provided in several ways. For example, the social media manager 224 may include a data collection or aggregation engine to perform the aggregation itself. Alternatively, or in combination with such an aggregation engine, the social media manager 224 may be configured to operate with other modules, internal or external to the enterprise 208, for collecting data regarding the users. For example, the social media manager 224 may be configured to operate with a third party aggregator system (not shown) connected to the network 212.

Furthermore, the social media manager 224 may be used to at least partially analyze the collected user's data. For example, the social media manager 224 may include a data analysis engine to identify Spam or irrelevant customer's context with respect to user's preference, to rank the information according to a relevance to a particular criterion, or to classify information according to subject, topic, user, product, and/or any other classification scheme. The social media manager 224 may also be configured to store the final, relevant user information in database 226.

As also shown in architecture 200, the connection between the user terminal 202 and agent terminal 210 may be provided via the agent routing module 228. In response to a user at the user terminal 202 selecting a particular contact option, the agent router 228 establishes the communication link associated with the selected contact option between the user terminal 202 and the agent terminal 210.

Although the social media manager 224 and the agent router 228 are shown as separate entities, the various embodiments are not limited in this regard. In some configuration, a single module may be used to implement the functionality of both the social media manager 224 and the agent router 228.

Further, according to an embodiment of the present invention, a badge-to-badge reader content transfer mechanism may be employed to transfer data from the badge to the badge reader. The content of the badge 214 are transferred to the badge reader 222 prior to the interaction between the user and the enterprise 208. The transfer mechanism depends on the communication modality between the user and the agent of the enterprise 208.

In one embodiment of the present invention, for voice interaction, the badge 214 transmits its content to the badge reader 222 through a phone modem-style voice modulation or through dual-tone multi-frequency (DTMF) signaling. In another embodiment of the present invention, for a video interaction, the badge 214 may display a QR code that encrypts badge's content and may be recognized by a QR code scanner installed in the badge reader 230. In yet another embodiment of the present invention, for a text chat, the badge 214 may compress its content into a text string and transmits it to the badge reader 222 during the chat setup. Such an interaction may also be carried out for email and web form interactions.

Further, according to an embodiment of the present invention, the badge 214 is not specific to a business or communication modality. The user may use the badge 214 when interacting with any business that is equipped with a badge reader 222, and over any of the common customer service communication modalities. Moreover, in the present embodiment the badges 214 provide a business with possibly extensive knowledge about the customer's persona, even if it is a new customer. Additionally, the present embodiment targets customization in contact centers, but the present embodiment may be broadened to personal interactions in stores and other places of business. The customized data provided by the badge 214 may be automatically mapped to a wide array of customization decisions at the outset of or during a customer service interaction.

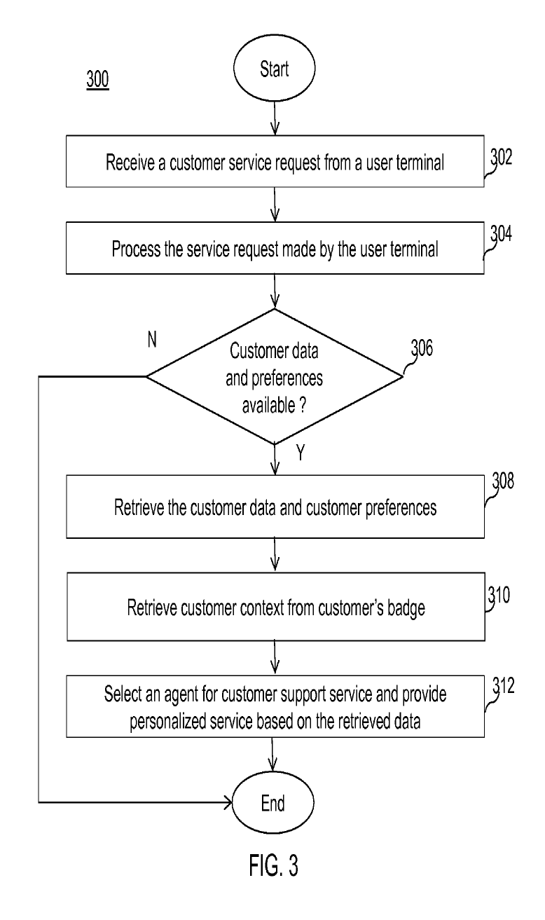

FIG. 3 illustrates a method 300 for providing customized customer service to the customers.

At step 302, a customer service request may be received by an enterprise 208 from a user terminal 202. In an embodiment of the present invention, a customer service request may be made by making a telephone call to the enterprise 208. In another embodiment of the present invention, the customer may request for a work request by sending text messages, emails, or web chats.

At step 304, the enterprise 208 processes the customer work request received from the user terminal 202 for providing customized service to the customer. In an embodiment, the enterprise may process the customer work request to determine a type of call e.g., telephone call, text message, email, etc. Further, the enterprise may retrieve details stored in the enterprise about the caller. If the caller has called previously, the enterprise may have information about the caller collected during the conversation.

At step 306, it is determined whether customer (i.e., user) data and/or customer preferences are available. Availability is determined at least in part by the customer permissions. If such data and preferences are not available, process 300 ends. Otherwise, process 300 continues to step 308.

At step 308, the enterprise 208 may retrieve user data as permitted by the access rights stored in the badge. In one embodiment of the present invention, a badge reader 222 at the enterprise 208 may retrieve the user data as permitted by the access rights set by the user of user terminal 202. The enterprise 208 may use the data as permitted by the user. Furthermore, in an embodiment, the enterprise 208 may also retrieve preference data about the user stored at the user terminal. The preference data include particular preferences of the user during the interaction with agent e.g., preferred call-back times (“not before 7 PM”, or “not on Mondays”), communication and customer service preferences (“I prefer voice interactions, with female customer service representatives, not younger than I am, fluent in Spanish, and with patience for tech-inexperienced customers”).

The user data may include contextual data about the user indicating preferences of the user. For example, if the user has a Facebook account, the reader module 230 enables the enterprise 208 to retrieve the user's name, gender, home and work locations, education level, work history, comments on the business' Facebook posts, etc.

In yet another embodiment of the present invention, the user data retrieved from the social network sites may also include information related to the user's action on the social network sites. This may be considered as a preferred mode of operation in a self service field where a company renders a marketing message to the users based on their preferences.

At step 312, the enterprise 208 may select an agent for providing customer service to the user based on the user data retrieved from the social network accounts of the user, and preference data retrieved from the user terminal. In one embodiment of the present invention, the enterprise 208 may select the agent based on the language, knowledge about issues, or previous interactions with the user. Further, in an optional step, resources at the enterprise (e.g., human agents or non-human agents) may serve the customer based on the user data and preference data to provide personalized service to the customer.

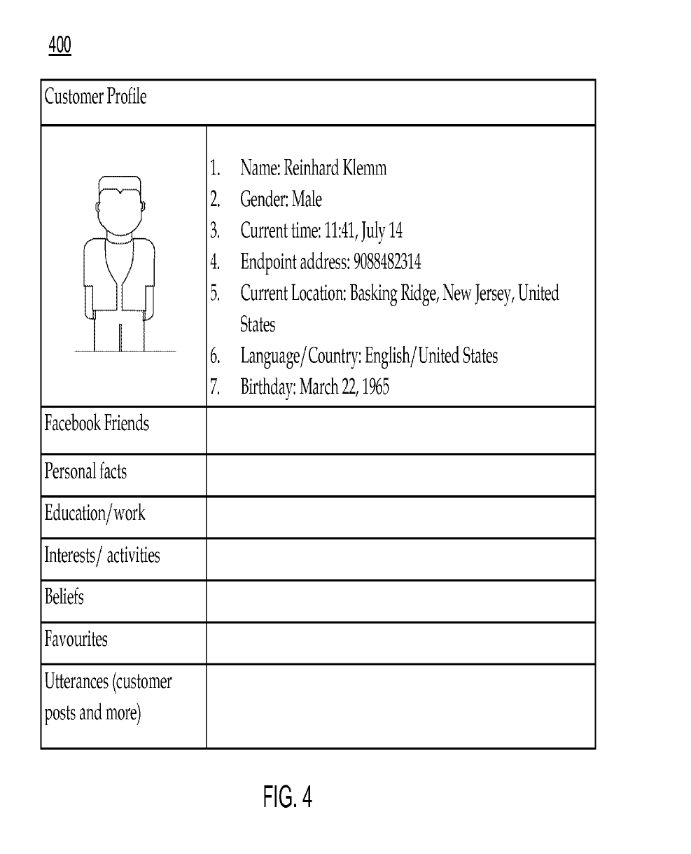

FIG. 4 illustrates user's profile page on an exemplary social network site. As shown in FIG. 4, the profile page 400 of the user on the social network site may provide information to the enterprise 208 to retrieve information to facilitate customer service. According to an embodiment of the present invention, the profile page 400 of the customer on the social network site may include user′ name, gender, work and home location, language, Facebook friends, education level, work history, favorite TV shows, books, or music. However, the various embodiments are not limited in this regard and other types of user data may also be provided without limitation.

The profile page 400 of the user on the social network site may also include additional information elements. For example, as shown in FIG. 4, the additional information elements may include additional characteristics of the user, such as personal facts, schooling, hobbies, and beliefs, to name a few. As a result, this information may help the agent of the enterprise 208 to improve the overall personalized customer service experience.

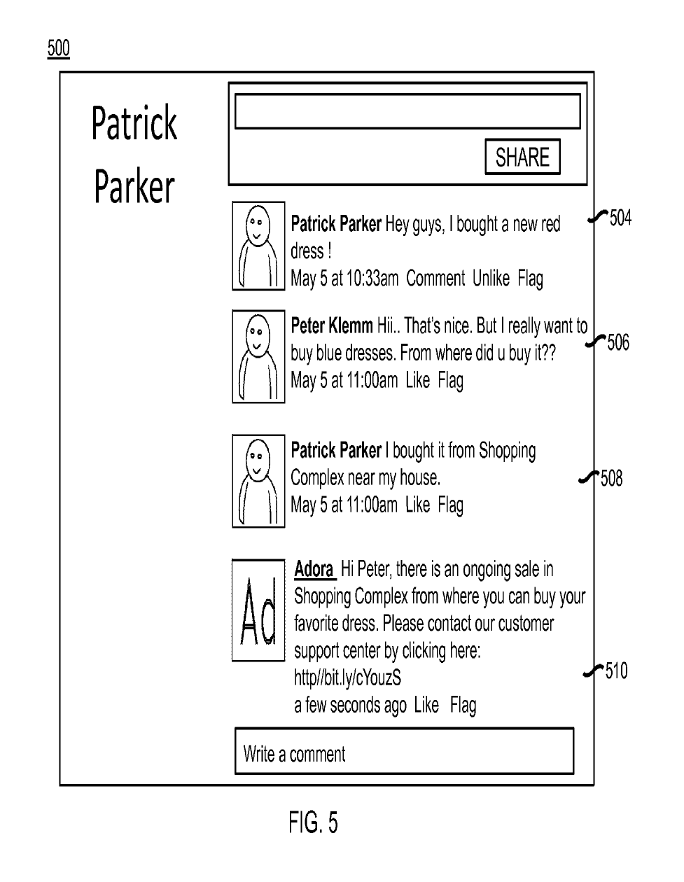

FIG. 5 illustrates user's comment on a friend's post on the social network site. The user may have commented on a friend's post 504 on the social network site. The enterprise 208 may retrieve the post and considered it as a user data to characterize user preferences and current needs, e.g., the post may show that the customer wants to buy a blue dress. The enterprise 208 may use this data to provide personalized service to the customer. Further, the enterprise 208 may use this data for effective and targeted marketing campaign, e.g., the enterprise 208 may post customized link 510 containing information that there may be an ongoing sale on such items. The customized post or message may also provide instructions to the customer on how to contact an agent of the enterprise 208.

As described above, the type of information provided to users may vary depending on the user's data. For example, a user associated with purchasing of a large number of products of the enterprise 208 may be considered as more “valuable” customer to the enterprise 208 than the users purchasing fewer products.

The exemplary systems and methods of embodiments of the present invention have been described in relation to a user device (e.g. smart device). However, to avoid unnecessarily obscuring the present invention, the preceding description omits a number of known structures and devices. This omission is not to be construed as a limitation of the scope of the claimed invention. Specific details are set forth to provide an understanding of embodiments of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that may be capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of embodiments of the present invention.

A number of variations and modifications of embodiments of the present invention can be made. It would be possible to provide for some features of embodiments of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this present invention. Exemplary hardware that can be used for embodiments of the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware may be used to implement the systems in accordance with this present embodiment are dependent on the speed and/or efficiency requirements of the system, the particular function, and the particular software or hardware systems or microprocessor or microcomputer systems being utilized.

In yet another embodiment of embodiments of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present embodiment can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although embodiments of the present invention describe components and functions implemented in the embodiments with reference to particular standards and protocols, embodiments of the present invention are not limited to such standards and protocols. Other similar standards and protocols not mentioned herein are in existence and are considered to be included in embodiments of the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in embodiments of the present invention.

Embodiments of the present invention, in various embodiments, configurations, and aspects, includes components, methods, processes, systems and/or apparatus substantially as depicted and described herein, including various embodiments, sub-combinations, and subsets thereof. Those of skill in the art will understand how to make and use embodiments of the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of embodiments of the present invention has been presented for purposes of illustration and description. The foregoing is not intended to limit the present invention to the form or forms or embodiments disclosed herein. In the foregoing Detailed Description for example, various features of embodiments of the present invention are grouped together in one or more embodiments, configurations, or aspects for the purpose of streamlining the disclosure. The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1-24. (canceled)

25. A system, comprising:
a memory; and
a processor configured to execute instructions stored on the memory, wherein executing the instructions comprises:
receiving a customer service request from a user terminal associated with a user;
retrieving one or more user-defined permissions stored in a memory of the user terminal to determine that first user data is available from one or more social media sources;
retrieving the first user data from the one or more social media sources;
retrieving second user data stored in the memory of the user terminal, wherein the second user data comprises user preference data provided by the user defining one or more preferences of the user for customer service communication;
selecting a first agent of a plurality of agents based on the first and second user data, the first agent having knowledge regarding one or more issues raised in the customer service request, the first agent having one or more previous interactions with the user, or a combination thereof;
establishing a communication session between the user terminal and an agent terminal associated with the selected first agent; and
providing first and second user data to the agent terminal for reference by the agent during the communication session.

26. The system of claim 25, wherein retrieving the first user data from the one or more social media sources comprises using one or more respective access keys to access the first user data from the one or more social media sources.

27. The system of claim 25, wherein executing the instructions comprises:
generating a first access key configured to allow access to first user data for a first social media source of the one or more social media sources; and
storing the first access key in the memory.

28. The system of claim 25, wherein the one or more social media sources comprise one or more direct social media channels.

29. The system of claim 25, wherein the one or more social media sources comprise one or more indirect social media channels.

30. The system of claim 25, wherein the first user data comprises publicly available social media data associated with the user.

31. The system of claim 25, wherein the first user data comprises data regarding interactions between the user and one or more other users within a first social media channel associated with a first social media source of the one or more social media sources.

32. A system, comprising:
a telecommunications device configured to receive an incoming customer service request from a user terminal associated with a user;
a storage medium configured to store a database comprising respective aggregated social media data for a plurality of users; and
a server, comprising:
a memory; and
a processor configured to execute instructions stored on the memory, wherein executing the instructions comprises:
processing a customer service request;
retrieving one or more user-defined permissions stored in a memory of the user terminal to determine that first user data is available from one or more social media sources;
retrieving the first user data from the one or more social media sources;
retrieving second user data stored in the memory of the user terminal, wherein the second user data comprises user preference data provided by the user;
selecting a first agent of a plurality of agents based on the first and second user data, the first agent having knowledge regarding one or more issues raised in the customer service request, the first agent having one or more previous interactions with the user, or a combination thereof;
establishing a communication session between the user terminal and an agent terminal associated with the selected first agent; and
providing first and second user data to the agent terminal for reference by the agent during the communication session.

33. The system of claim 32, wherein retrieving the first user data from the one or more social media sources comprises using one or more respective access keys to access the first user data from the one or more social media sources.

34. The system of claim 32, wherein executing the instructions comprises:
generating a first access key configured to allow access to first user data for a first social media source of the one or more social media sources; and
storing the first access key in the memory.

35. The system of claim 34, wherein executing the instructions comprises:
generating a second access key configured to allow access to first user data for a second social media source of the one or more social media sources; and
storing the second access key in the memory.

36. The system of claim 32, wherein the one or more social media sources comprise one or more indirect social media channels, one or more direct social media channels, or a combination thereof.

37. The system of claim 32, wherein the first user data comprises publicly available social media data associated with the user.

38. The system of claim 32, wherein the first user data comprises data regarding interactions between the user and one or more other users within a first social media channel associated with a first social media source of the one or more social media sources.

39. A method, comprising:
receiving a customer service request from a user terminal associated with a user;
retrieving one or more user-defined permissions stored in a memory of the user terminal to determine that first user data is available from one or more social media sources;
retrieving the first user data from the one or more social media sources;
retrieving second user data stored in the memory of the user terminal, wherein the second user data comprises user preference data provided by the user;
selecting a first agent of a plurality of agents based on the first and second user data, the first agent having knowledge regarding one or more issues raised in the customer service request, the first agent having one or more previous interactions with the user, or a combination thereof;
establishing a communication session between the user terminal and an agent terminal associated with the selected first agent; and
providing first and second user data to the agent terminal for reference by the agent during the communication session.

40. The method of claim 39, comprising:
generating a first access key configured to allow access to first user data for a first social media source of the one or more social media sources; and
storing the first access key in memory.

41. The method of claim 40, comprising using the first access key to access the first user data from the first social media source.

42. The method of claim 41, comprising:
generating a second access key configured to allow access to the first user data for a second social media source of the one or more social media sources; and
storing the second access key in memory.

43. The method of claim 42, comprising using the second access key to access the first user data from the second social media source.

44. The method of claim 39, wherein the first user data comprises publicly available social media data associated with the user.
